(19) United States
(12) Patent Application Publication
(10) Pub. No.: US 2022/0132317 A1
(43) Pub. Date: Apr. 28, 2022

(54) SAFE USER SUBSCRIPTION PROFILE MODIFICATION FOR AUTONOMOUS DEVICES

(71) Applicant: Telefonaktiebolaget LM Ericsson (publ), Stockholm (SE)

(72) Inventors: Rémi ROBERT, Solna (SE); Jinhua FENG, Täby (SE); Morgan LINDQVIST, Sundbyberg (SE); Aleksandra OBESO DUQUE, Solna (SE)

(21) Appl. No.: 17/431,271

(22) PCT Filed: Feb. 19, 2019
(86) PCT No.: PCT/SE2019/050147

§ 371 Date: Aug. 16, 2021

(51) Int. Cl. H04W 12/30; H04W 12/63; H04W 12/72; H04W 8/20

(52) U.S. Cl. CPC H04W 12/35; H04W 8/205; H04W 12/72; H04W 12/63

(57) ABSTRACT

Methods and devices of determining and controlling whether or not a user subscription profile hosted on an embedded Universal Integrated Circuit Card (eUICC) of a user device is allowed to be modified. In an aspect, a method of a network node of determining whether or not a user subscription profile hosted on an eUICC of a user device is allowed to be modified is provided. The method includes receiving a request to modify the user subscription profile of the user device, acquiring, from a network node configured to store user subscription information, information indicating if the user device is an autonomous device, and if so acquiring, information indicating operational status of the user device, and allowing the user subscription profile to be modified if the information indicating operational status of the user device indicates that the user device currently not is in operation.

### TECHNICAL FIELD

The invention relates to methods and devices of determining and controlling whether or not a user subscription profile hosted on an embedded Universal Integrated Circuit Card (eUICC) of a user device is allowed to be modified.

### BACKGROUND

Autonomous vehicles such as autonomous cars and unmanned aerial vehicles (UAVs), also named drones, are cars/aircrafts without a human driver/pilot aboard. Further autonomous vehicles are for instance robotic vacuum cleaners and robotic lawn mowers.

In the future, it is expected that many self-driving cars and drones (and potentially other autonomous vehicles) will need to be connected to a mobile network (first 4G and then 5G) to carry out their task. This connectivity will be utilized for transporting control signalling required for controlling the vehicle as well as for transferring payload application data.

One major issue differentiating the autonomous vehicles with mobile connectivity from other “traditional” mobile communication terminals, such as e.g. smart phones, tablets and gaming terminals, is that in some cases connectivity will be a requirement for their safe operation (for instance for a remote-controlled UAV). Disrupting the connectivity—even for a limited time—might have severe consequences.

Utilizing embedded Universal Integrated Circuit Card (eUICC) technology in autonomous devices facilitates remote management of a user subscription profile hosted by the eUICC being used by the device. However, the use of eUICCs also increases the risk of unintentionally or deliberately disabling/disrupting the connectivity of the autonomous devices performing an assignment, thereby increasing the risk for accidents to happen.

### SUMMARY

An object of the present invention is to solve, or at least mitigate, this problem and thus to provide a method of safely modifying a user subscription profile hosted by an eUICC of an autonomous device.

This objective is attained in a first aspect of the invention by a method of a network node of determining whether or not a user subscription profile hosted on an eUICC of a user device is allowed to be modified. The method comprises receiving a request to modify said user subscription profile of the user device, acquiring, from a network node configured to store user subscription information, information indicating if the user device is an autonomous device, and if so acquiring information indicating operational status of the user device, and allowing the user subscription profile to be modified if the information indicating operational status of the user device indicates that the user device currently not is in operation.

This objective is attained in a second aspect of the invention by a network node configured to determine whether or not a user subscription profile hosted on an eUICC of a user device is allowed to be modified. The network node comprises a processing unit and a memory, said memory containing instructions executable by said processing unit, whereby the network node is operative to receive a request to modify said user subscription profile of the user device, acquire, from a network node configured to store user subscription information, information indicating if the user device is an autonomous device, and if so acquire information indicating operational status of the user device, and allow the user subscription profile to be modified if the information indicating operational status of the user device indicates that the user device currently not is in operation.

This objective is attained in a third aspect of the invention by a method of a subscription manager entity of controlling modification of a user subscription profile hosted on an eUICC of a user device (10). The method comprises receiving a request to modify the user subscription profile of the user device, acquiring, from a network node, information configured to indicate whether or not the user subscription profile of the user device is allowed to be modified, and if so modify the user subscription profile of the user device 10).

This objective is attained in a fourth aspect of the invention by a subscription manager entity configured to control modification of a user subscription profile hosted on an eUICC of a user device. The subscription manager entity comprises a processing unit and a memory, said memory containing instructions executable by said processing unit, whereby the subscription manager entity is operative to receive a request to modify the user subscription profile of the user device, acquire, from a network node, information configured to indicate whether or not the user subscription profile of the user device is allowed to be modified, and if so modify the user subscription profile of the user device.

Advantageously, by verifying that a user subscription profile hosted by a user device can be safely modified, any connectivity-disrupting eUICC management operation to be performed while the user device is in operation is prevented. Such verification increases the safety of eUICC integration in ecosystems hosting user devices in the form of autonomous devices.

In an embodiment, the network node being configured to determine whether or not a user subscription profile hosted on an eUICC of a user device is allowed to be modified acquires, from a network node configured to store information related to scheduled user device assignments, information indicating whether or not the user device is scheduled for operation; wherein the allowing of the user subscription profile to be modified further comprises allowing the user subscription profile (12) to be modified if the acquired scheduling information indicates that the user device (10) is not scheduled for operation within a predetermined time period.

In an embodiment, the predetermined time period varies depending on an extent of the user subscription profile modification to be performed.

In an embodiment, the request comprises an International Mobile Subscriber Identity (IMSI) associated with the user subscription profile and/or an identifier of the eUICC on which the user subscription profile is hosted and/or an identifier of the user device.

In an embodiment, the network node being configured to determine whether or not a user subscription profile hosted on an eUICC of a user device is allowed to be modified is configured to further acquire a current location of the user device, wherein the allowing of the user subscription profile to be modified further comprises allowing the user subscription profile to be modified if the acquired location information indicates that the user device is in a location where user subscription profile modification is allowed regardless of user device operational status.

In an embodiment, the acquiring of information indicating operational status of the user device comprises acquiring, from a network node configured to manage mobility of the user device, information indicating operational status of the user device.

In an embodiment, the acquiring of information indicating operational status of the user device comprises acquiring, from the user device, information indicating operational status of the user device.

In an embodiment, the network node being configured to determine whether or not a user subscription profile hosted on an eUICC of a user device is allowed to be modified acquires, from a network node configured to manage mobility of the user device, address information of the user device.

In an embodiment, the subscription manager entity configured to control modification of a user subscription profile hosted on an eUICC of a user device subscribing to a change in the information indicating either that the user subscription profile (12) of the user device (10) has changed to currently not be allowed to be modified, or that the user subscription profile (12) of the user device (10) has changed to currently being allowed to be modified.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 illustrates a prior art system for provisioning an eUICC of a UAV with a user subscription profile;

FIG. 2 illustrates a network node utilized for safely allowing modification of a user subscription profile hosted by an eUICC of a UAV according to an embodiment;

FIG. 3 illustrates a method of checking whether a user subscription profile can be safely modified according to an embodiment;

FIG. 4 illustrates a method of checking whether a user subscription profile can be safely modified according to another embodiment;

FIG. 5 illustrates a method of checking whether a user subscription profile can be safely modified according to a further embodiment;

FIG. 6 shows a timing diagram illustrating a method of safely modifying a user subscription profile according to an embodiment;

FIG. 7 illustrates a method of checking whether a user subscription profile can be safely modified according to an embodiment;

FIG. 8 illustrates a USV according to an embodiment; and

FIG. 9 illustrates an SM-SR entity according to an embodiment.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

Historically, every cellular device, such as a mobile phone, smartphone, or any other mobile terminal which is configured for communicating over a cellular radio access network, such as Global System for Mobile Communications (GSM), Universal Mobile Telecommunications System (UMTS), or Long-Term Evolution (LTE), has been equipped with a removable Universal Integrated Circuit Card (UICC). The UICC is a smart card defined in ETSI TR 102 216. It typically contains a number of applications, in particular the Subscriber Identity Module (SIM) application for use in GSM networks and the Universal SIM (USIM) for use in UMTS and LTE networks. The SIM and USIM store the International Mobile Subscriber Identity (IMSI) and one or more keys, or shared secrets, for deriving keys used to identify and authenticate subscribers on mobile networks and for services provided by these networks.

Recently, the GSM Association (GSMA) has published specifications for a non-removable UICC, referred to as the embedded UICC or plainly eUICC. The eUICC contains an eSIM application, and the terms non-removable SIM, embedded SIM, and eSIM, are often used synonymously. The eUICC and its embedded SIM have the same functionality as the traditional UICC with its SIM and USIM, but the eUICC has a different form factor and is typically designed to be permanently soldered into a mobile terminal, rather than being removable. The eUICC is a smart card, similar to the UICC, i.e., an electronic device comprising embedded electronic circuits, such as a processor and memory.

By using eUICCs, the mobile terminal may be provisioned for the first time with its first commercial operator (“bootstrapping”), i.e. a Mobile Network Operator (MNO), in an Over The Air (OTA) manner; that is without physically accessing the mobile terminal, in contrast to today's manually procedure which involves physically swapping the UICC. Other use-cases are, e.g., a “change of operator profile”, i.e., when operator credentials on an eUICC are changed from a current commercial operator to a new commercial operator. As a further example, use-cases may also include “subscription transfer”, i.e., when the operator credentials residing on a current eUICC are transferred to a new eUICC.

To provide mobile connectivity for autonomous vehicles, the manufacturers of the vehicles are expected to use eUICC. This technology defines a chain of trust between several entities that is used to provision the UE with profiles allowing it to connect the mobile networks.

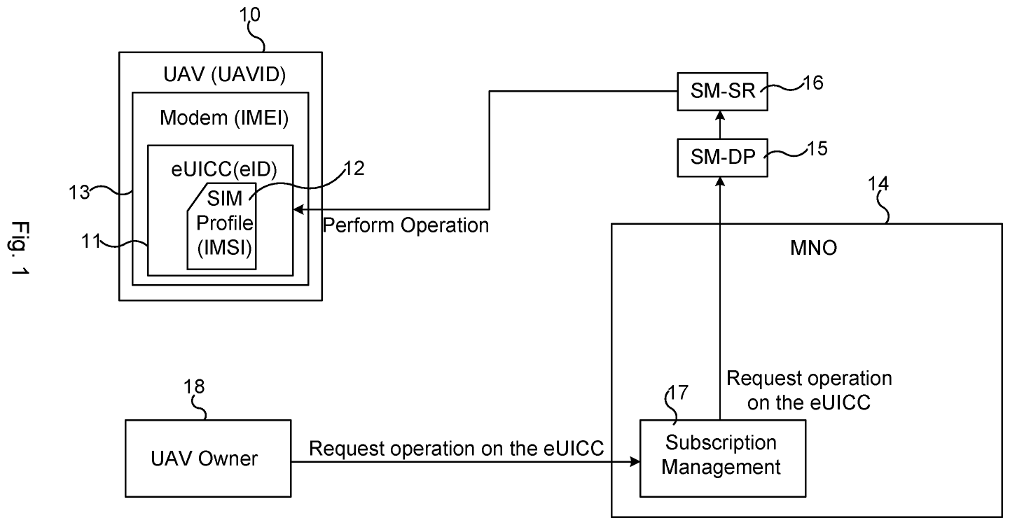

FIG. 1 illustrates a prior art system for supplying a device 10 such as an autonomous vehicle with an eUICC 11 and provisioning the eUICC 11 with a SIM profile 12 such that the device 10 can be operated. The eUICC 11 is embedded in a 3GGP modem 13 enabling wireless communication with the device 10. In the following, the device 10 will be exemplified in the form of a UAV. However, the process may alternatively be performed for wireless communication devices such as smart phone, tablets, laptops, autonomous cars, etc.

The UAV 10 is identified by an identifier referred to as UAVID, the eUICC 11 is identified by an identifier referred to as an eID, the SIM profile 12 is identified by an International Mobile Subscriber Identity (IMSI), and the modem 13 is identified by an International Mobile Equipment Identity (IMEI).

The provisioning of the SIM profile 12 to the eUICC 11 of the UAV 10 is performed by an MNO 14.

The MNO 14 typically cooperates with a Subscription Manager Data Preparation (SM-DP) entity 15 responsible for securely encrypting operator credentials ready for OTA installation. If the MNO 14 needs to create a new SIM profile 12, it orders one from the SM-DP entity 15. It is noted that the SIM profile 12 need not contain any indication that it is to be used by an autonomous device such as a UAV, even though the MNO 14 may include such an indication.

The MNO 14 further cooperates with a Subscription Manager Secure Routing (SM-SR) entity 16 which enables secure download, enablement, disablement and deletion of profiles on the eUICC 11.

Moreover, the MNO 14 hosts a Subscription Management entity 17 responsible for device-specific subscriptions. This enables the MNO 14 to provide differentiated services for different device categories.

In order to provision the eUICC 11 with the SIM profile 12, the owner 18 of the UAV 10 sends a provisioning request to the MNO 14 comprising the eID of the eUICC 11 embedded in the UAV 10 as well as an appropriate identifier—e.g. the IMSI—of the subscriber associated with the SIM profile 12 with which the eUICC 11 is to be provisioned. The owner 18 may be an individual or a company owning the UAV 10.

In response to receiving the request, the Subscription Management entity 17 provisions, via the SM-DP entity 15 and the SM-SR entity 16, the eUICC 11 identified by the eID with the SIM profile 12 associated with the IMSI previously received from the UAV owner 18.

The eUICC technology facilitates remote management of the SIM profile 12 being used by the UAV 10. It is thus technically possible to disable/disrupt the connectivity of the UAV 10 (be it by mistake or with mischievous intents) currently being an operation, e.g. performing an assignment, thereby increasing the risk for accidents to happen.

Beyond just the management of eUICC 11, the MNO 14 might also want to perform operations that may result in disturbance in the wireless connection of the UAV 10. Even if the MNO 14 knows that the subscription is used in a UAV 10, the MNO 14 has currently no way of acquiring information indicating whether or not it is safe at a given moment to perform maintenance operations on the subscription, such as for instance changing Access Point Name (APN) to have the UAV 10 switch from a current network to another.

Now, assuming that the UAV owner 18 would want to remotely modify the SIM profile 12, e.g. by performing a change of MNO from an existing MNO to a new MNO, the UAV owner 18 would simply send a request accordingly to the MNO 14 which would perform the action. In case the UAV 10 is in operation, this is a potentially hazardous action which could cause a disruption in the wireless connection of the UAV 10 and ultimately cause the UAV 10 to crash.

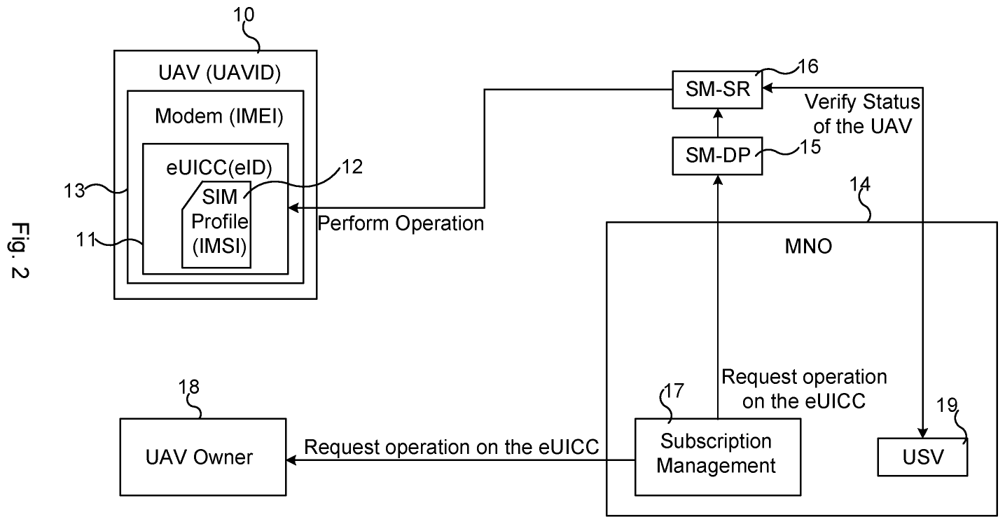

FIG. 2 illustrates a node referred to in the following as a UAV Status Verifier (USV) 19 according to an embodiment. FIG. 2 illustrates the USV 19 being implemented in the system previously described with reference to FIG. 1. In FIG. 2, the USV 19 is exemplified to be comprised in the MNO 14 in communication with the SM-SR entity 16 even though other configurations may be envisaged.

As will be described in the following, The USV 19 is configured to acquire information regarding operational status of the UAV 10, i.e. whether the UAV 10 is in operation or not. Thus, if any modification of the SIM profile 12 is to be performed, e.g. if the UAV owner 18 would want to remotely manage the SIM profile 12 of the eUICC 11, or if the MNO 14 would want to perform maintenance operations on the subscription included in the SIM profile 12, the SM-SR entity 16 will verify the status of the UAV 10 by checking with the USV 19.

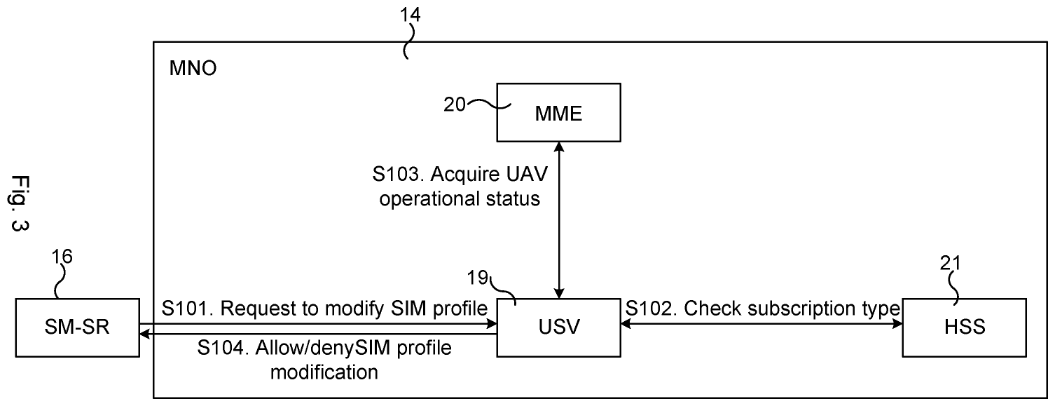

FIG. 3 illustrates the USV 19 acquiring UAV operational status according to an embodiment. The MNO 14 hosts a Mobility Management Entity 20 (MME) which is a standard node in LTE. The MME 20 is responsible for managing mobility of User Equipment (UE), such as e.g. idle mode UE tracking and paging procedure including retransmissions. In this description, the UE will be exemplified by the UAV 10.

Further, the MNO 14 hosts a Home Subscriber Server 21 (HSS) being a central database that contains user-related and subscription-related information. The functions of the HSS 21 include functionalities such as storing user subscription information, call and session establishment support, user authentication and access authorization.

Now, assuming that modification of the SIM profile 12 is to be performed either by the UAV owner 18 or the MNO 14; the SM-SR entity 16 thus sends a request accordingly to the USV 19 in step S101. The user subscription profile (i.e. the SIM profile 12) of the UAV 10 may for instance be identified by including the IMSI in the request.

Upon receiving the request, the USV 19 acquires in step S102, from the HSS 21, information indicating whether or not the user device 10 comprising the eUICC 11 hosting the SIM profile 12 identified with the IMSI is an autonomous device or not. Hence, the IMSI of the SIM profile 12 would typically be registered at the HSS 21 and associated with the UAVID and/or the eID of the eUICC 11 of the UAV 10. This may be performed when the UAV 10 initially is registered with the MNO 14. In particular, the HSS 21 is capable of providing information as to whether the user device 10 for which the information is requested by providing the IMSI is an autonomous device or—for instance—an ordinary mobile phone; unless the user device 10 is an autonomous device such as e.g. a UAV or an autonomous car, the modification of the SIM profile 12 is not considered a critical action.

In this particular exemplifying embodiment, the USV 19 acquires information from the HSS 21 in step S102 indicating that the user device 10 indeed is a UAV. Consequently, the USV 19 will acquire information indicating operational status of the UAV 10 from the MME 20 in step S103. That is; whether the UAV 10 is in operation—i.e. in the air—or not. Generally, the MME 20 is only aware of whether the UAV 10 is connected to the network or not. Hence, the USV 19 will conclude that the UAV 10 indeed is airborne if the MME 20 indicates that the UAV 10 is connected to the network.

If the MME 20 indicates to the USV 19 that the UAV 10 is airborne, the USV 19 will respond to the SM-SR entity 16 in step S104 that modification of the SIM profile 12 is denied due to the risk of causing critical disruption of the wireless communication of the airborne UAV 10 with a potentially hazardous result.

In contrast, should the MME 20 indicate that the UAV 10 is not airborne in step S103, the USV 19 will indicate to the SM-SR entity 16 in step S104 that modification of the SIM profile 12 is allowed, and the MNO 14 can proceed with performing the modification of the SIM profile 12 accordingly.

The information received from the MME 20 in step S103 may include information relating to Evolved Packet System (EPS) Mobility Management (EMM) and EPS Connection Management (ECM) states. For instance, these states may indicate whether or not the UAV 10 has one or more active Packet Data Network (PDN) connections.

In an embodiment, it is envisaged that the SM-SR entity 16 subscribes to a change in the operational status of the UAV 10. For instance, the SM-SR entity 16 may previously have been denied a SIM profile modification and thus wishes to be notified as soon as it is safe to perform the operation on the eUICC 11.

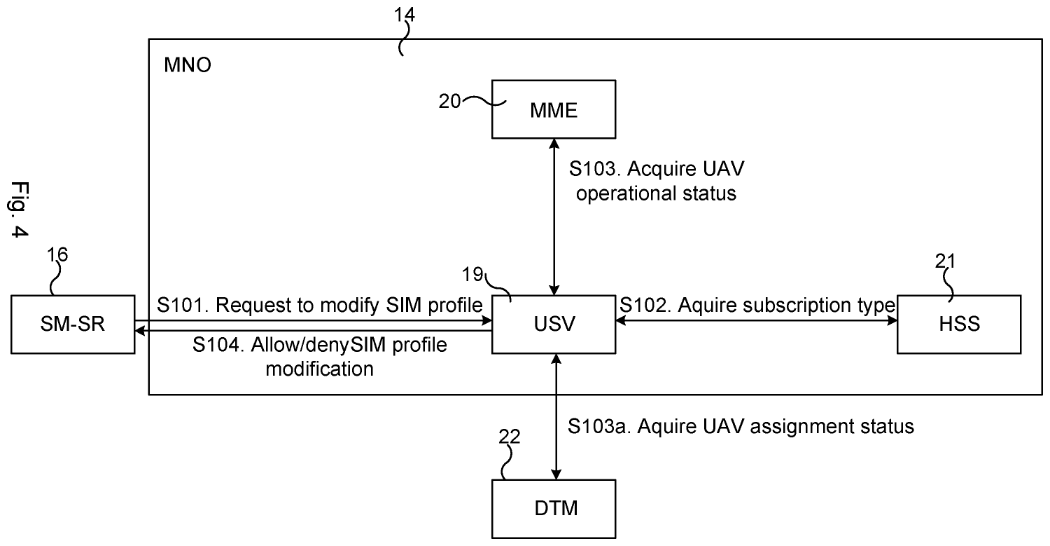

FIG. 4 illustrates the USV 19 acquiring UAV assignment scheduling status according to an embodiment. In this embodiment, the system further comprises a Drone Traffic Management (DTM) node 22 being a designated node in the UAV ecosystem that keeps track of scheduled assignments of the different UAVs.

In this embodiment, after the USV 19 has acquired UAV operational status from the MME 20 in step S103, the USV 19 acquires information in step S103a from the DTM node 22 indicating if the UAV 10 is scheduled for operation.

Hence, even though the MME 20 indicates in step S103 that the UAV 10 currently not is in operation, the DTM node 22 may indicate in step 103a that the UAV 10 is scheduled for operation within a given time period, say within 10 minutes.

If so, the USV 19 may indicate to the SM-SR entity 16 in step S104—for precautionary reasons—that modification of the SIM profile 12 is not allowed even though the UAV 10 currently is not airborne. For instance, the duration of a modification of the SIM profile 12 may last longer than 10 minutes in which case the modification would be ongoing at the instant in time when the UAV 10 is scheduled to be airborne.

The UAV 10 can be identified by providing its UAVID, or the eID of its eUICC 12, with the request sent to the DTM node 22 in step S103a.

In an embodiment, the time period during which modification is allowed varies depending on the extent of the modification to be performed. For instance, if a minor modification is to be undertaken, the modification may be allowed if the UAV 10 is not scheduled for operation within the next 3-4 minutes, while if a major modification is to be undertaken, the modification will only be allowed if the UAV 10 is not scheduled for operation within, say, the next 20 minutes.

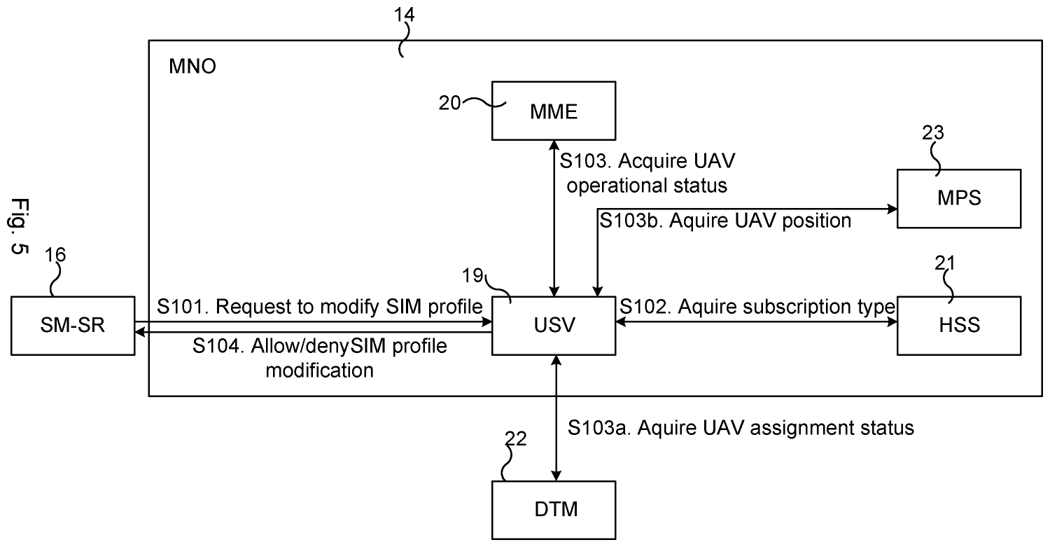

FIG. 5 illustrates the USV 19 acquiring UAV position according to an embodiment. In this embodiment, the MNO 14 further hosts a Mobile Positioning System (MPS) 23 offering services allowing a user to request location (altitude, longitude and elevation) of a UAV 10. These may current and/or historical values. In this embodiment, it is envisaged that certain locations would allow modification of the SIM profile 12 of a UAV 10, even if the UAV 10 is airborne, such as for instance if the UAV 10 is flying over an area of woodland. If so, step S103a is not necessarily performed.

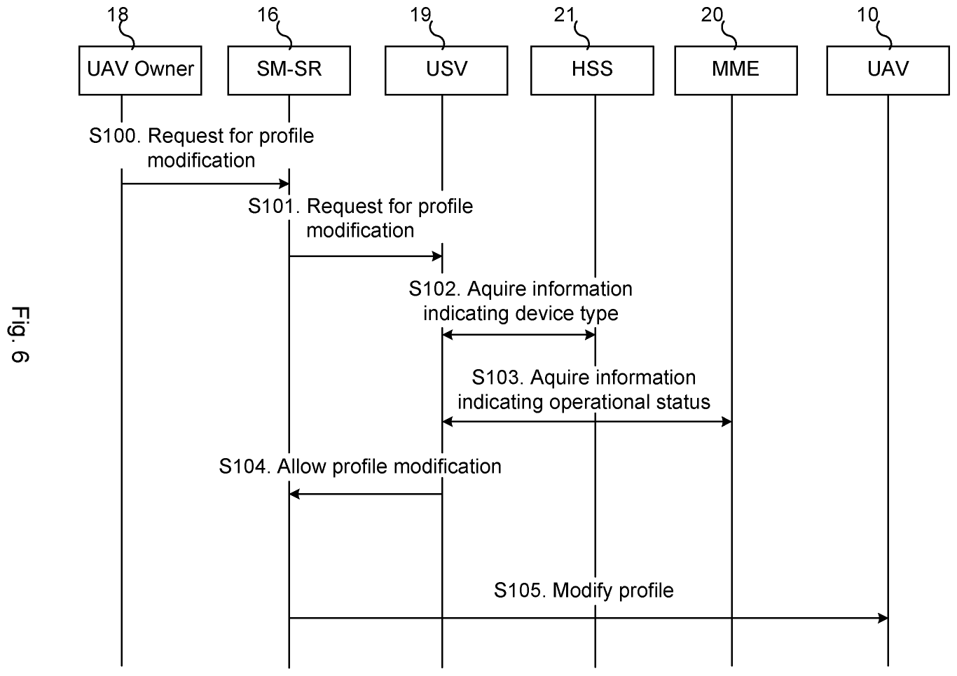

FIG. 6 shows a timing diagram illustrating a full process of requesting UAV operational status and modifying the SIM profile 12 hosted by the eUICC 11 of the UAV 10.

In a first step S100, the UAV owner 18 sends a request for profile modification to the SM-SR entity 16 (via the Subscription Management entity 17 and the SM-DP entity 15, not shown in the timing diagram). The SM-SR entity 16 in its turn sends the request to the USV 19 in step S101.

Upon receiving the request, the USV 19 acquires in step S102, from the HSS 21, information indicating whether or not the user device 10 comprising the eUICC 11 hosting the SIM profile 12 identified with the IMSI is an autonomous device or not. In this particular exemplifying embodiment, the USV 19 acquires information from the HSS 21 in step S102 indicating that the user device 10 indeed is a UAV.

The USV 19 then acquires information indicating operational status of the UAV 19 from the MME 20 in step S103. That is; whether the UAV 19 is airborne or not.

In this example, the MME 20 indicates that the UAV 10 is not airborne in step S103, and the USV 19 will indicate to the SM-SR entity 16 in step S104 that modification of the SIM profile 12 is allowed.

Finally, the SM-SR entity 16 proceeds with performing the modification of the SIM profile 12 in line with the request received in step S100.

Advantageously, the MNO 14 may (for example via the SM-SR entity 16) verify that the SIM profile 12 hosted by the UAV 10 can be safely modified, thereby preventing any connectivity-disrupting eUICC management operation to be performed while the associated UAV is airborne. Such verification increases the safety of the eUICC integration in the UAV ecosystem.

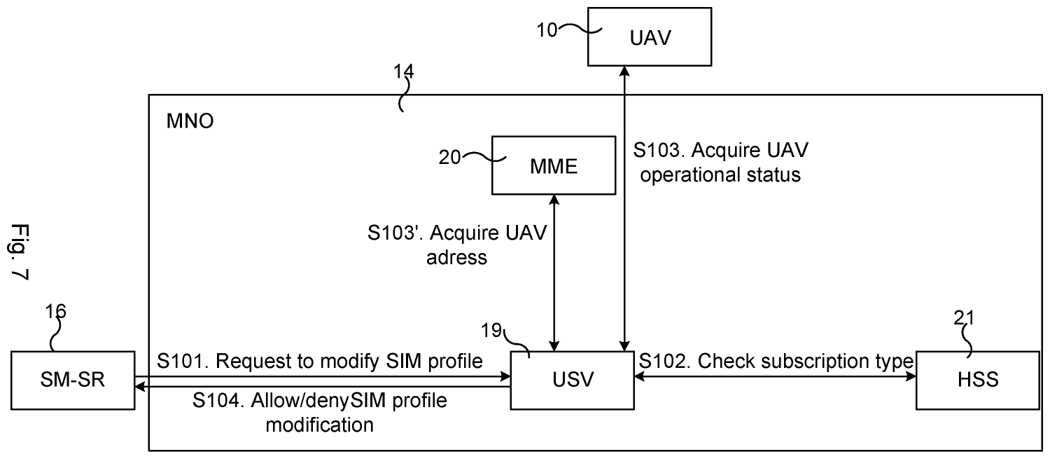

FIG. 7 illustrates the USV 19 acquiring UAV operational status according to another embodiment.

Assuming that modification of the SIM profile 12 is to be performed either by the UAV owner 18 or the MNO 14; the SM-SR entity 16 thus sends a request accordingly to the USV 19 in step S101. The user subscription profile (i.e. the SIM profile 12) of the UAV 10 may for instance be identified by including the IMSI in the request.

Upon receiving the request, the USV 19 acquires in step S102, from the HSS 21, information indicating whether or not the user device 10 comprising the eUICC 11 hosting the SIM profile 12 identified with the IMSI is an autonomous device or not. Hence, the IMSI of the SIM profile 12 would typically be registered at the HSS 21 and associated with the UAVID and/or the eID of the eUICC 11 of the UAV 10. This may be performed when the UAV 10 initially is registered with the MNO 14. In particular, the HSS 21 is capable of providing information as to whether the user device 10 for which the information is requested by providing the IMSI is an autonomous device or—for instance—an ordinary mobile phone; unless the user device 10 is an autonomous device such as e.g. a UAV or an autonomous car, the modification of the SIM profile 12 is not considered a critical action.

In this particular exemplifying embodiment, the USV 19 acquires information from the HSS 21 in step S102 indicating that the user device 10 indeed is a UAV. In contrast to the embodiment described with reference to FIG. 3, the USV 19 will acquire address information designating the UAV 10 from the MME 20 in step S103′, such as e.g. the Internet Protocol (IP) address of the UAV 10.

Thereafter, the USV 19 will turn directly to the UAV in step S103c in order to acquire information indicating operational status of the UAV 10. That is; whether the UAV 10 is in operation—i.e. in the air—or not. Generally, the MME 20 is only aware of whether the UAV 10 is connected to the network or not. Hence, the USV 19 will achieve more precise operational information by turning directly to the UAV 10.

In case the UAV 10 is airborne, the USV 19 responds to the SM-SR entity 16 in step S104 that modification of the SIM profile 12 is denied due to the risk of causing critical disruption of the wireless communication of the airborne UAV 10 with a potentially hazardous result.

In contrast, should the UAV 10 indicate in step S103c that it is not airborne, the USV 19 will indicate to the SM-SR entity 16 in step S104 that modification of the SIM profile 12 is allowed, and the MNO 14 can proceed with performing the modification of the SIM profile 12 accordingly.

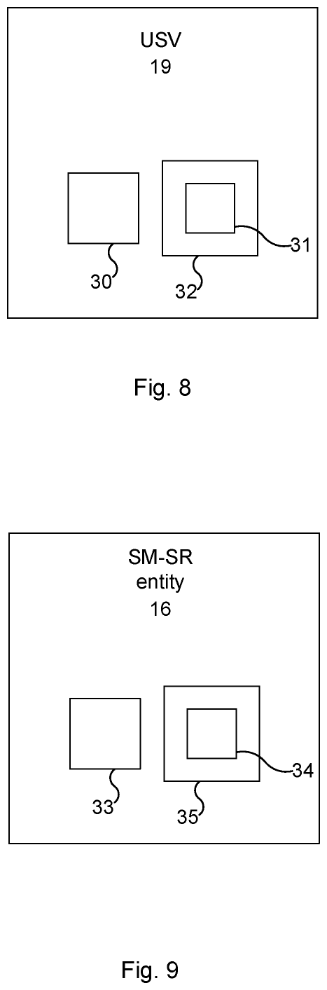

FIG. 8 illustrates a USV 19 according to an embodiment. The steps of the method performed by the USV 19, being embodied e.g. in the form of a computer, of determining whether or not a user subscription profile hosted on an eUICC of a user device is allowed to be modified according to embodiments are in practice performed by a processing unit 30 embodied in the form of one or more microprocessors arranged to execute a computer program 31 downloaded to a suitable storage volatile medium 32 associated with the microprocessor, such as a Random Access Memory (RAM), or a non-volatile storage medium such as a Flash memory or a hard disk drive. The processing unit 30 is arranged to cause the USV 19 to carry out the method according to embodiments when the appropriate computer program 31 comprising computer-executable instructions is downloaded to the storage medium 32 and executed by the processing unit 30. The storage medium 32 may also be a computer program product comprising the computer program 31. Alternatively, the computer program 31 may be transferred to the storage medium 32 by means of a suitable computer program product, such as a Digital Versatile Disc (DVD) or a memory stick. As a further alternative, the computer program 31 may be downloaded to the storage medium 32 over a network. The processing unit 3o may alternatively be embodied in the form of a digital signal processor (DSP), an application specific integrated circuit (ASIC), a field-programmable gate array (FPGA), a complex programmable logic device (CPLD), etc.

FIG. 9 illustrates an SM-SR entity 16 according to an embodiment. The steps of the method performed by the SM-SR entity 16, being embodied e.g. in the form of a computer, of controlling modification of a user subscription profile hosted on an eUICC of a user device according to embodiments are in practice performed by a processing unit 33 embodied in the form of one or more microprocessors arranged to execute a computer program 34 downloaded to a suitable storage volatile medium 35 associated with the microprocessor, such as a RAM, or a non-volatile storage medium such as a Flash memory or a hard disk drive. The processing unit 33 is arranged to cause the SM-SR entity 16 to carry out the method according to embodiments when the appropriate computer program 34 comprising computer-executable instructions is downloaded to the storage medium 35 and executed by the processing unit 33. The storage medium 35 may also be a computer program product comprising the computer program 34. Alternatively, the computer program 34 may be transferred to the storage medium 35 by means of a suitable computer program product, such as a DVD or a memory stick. As a further alternative, the computer program 34 may be downloaded to the storage medium 25 over a network. The processing unit 33 may alternatively be embodied in the form of a DSP, an ASIC, an FPGA, a CPLD, etc.

The invention has mainly been described above with reference to a few embodiments. However, as is readily appreciated by a person skilled in the art, other embodiments than the ones disclosed above are equally possible within the scope of the invention, as defined by the appended patent claims.

1. A method of a network node of determining whether or not a user subscription profile hosted on an embedded Universal Integrated Circuit Card, eUICC, of a user device is allowed to be modified, the method comprising:
receiving a request to modify the user subscription profile of the user device; and
acquiring, from a network node configured to store user subscription information, information indicating if the user device is an autonomous device; and if so:
acquiring, information indicating operational status of the user device; and
allowing the user subscription profile to be modified if the information indicating operational status of the user device indicates that the user device currently not is in operation.

2. The method of claim 1, further comprising:
acquiring, from a network node configured to store information related to scheduled user device assignments, information indicating whether or not the user device is scheduled for operation, wherein the allowing of the user subscription profile to be modified further comprises:
allowing the user subscription profile to be modified if the acquired scheduling information indicates that the user device is not scheduled for operation within a predetermined time period.

3. The method of claim 2, wherein the predetermined time period varies depending on an extent of the user subscription profile modification to be performed.

4. The method of claim 1, wherein the request comprises at least one of:
an International Mobile Subscriber Identity, IMSI, associated with the user subscription profile;
an identifier of the eUICC on which the user subscription profile is hosted; and
an identifier of the user device.

5. The method of claim 1, further comprising:
acquiring a current location of the user device, wherein the allowing of the user subscription profile to be modified further comprises:
allowing the user subscription profile to be modified if the acquired location information indicates that the user device is in a location where user subscription profile modification is allowed regardless of user device operational status.

6. The method of claim 1, wherein the acquiring of information indicating operational status of the user device comprises:
acquiring, from a network node configured to manage mobility of the user device, information indicating operational status of the user device.

7. The method of claim 1, wherein the acquiring of information indicating operational status of the user device comprises:
acquiring, from the user device OK information indicating operational status of the user device.

8. The method of claim 7, further comprising:
acquiring, from a network node configured to manage mobility of the user device, address information of the user device.

9. A method of a subscription manager entity of controlling modification of a user subscription profile hosted on an embedded Universal Integrated Circuit Card, eUICC, of a user device, the method comprising:
receiving a request to modify the user subscription profile of the user device;
acquiring, from a network node, information configured to indicate whether or not the user subscription profile of the user device is allowed to be modified; and if so:
modifying the user subscription profile of the user device.

10. The method of claim 9, wherein the request comprises at least one of:
an International Mobile Subscriber Identity, IMSI, associated with the user subscription profile;
an identifier of the eUICC on which the user subscription profile is hosted; and
an identifier of the user device.

11. The method of claim 9, wherein the acquiring of the information configured to indicate whether or not the user subscription profile of the user device is allowed to be modified comprises:
subscribing to a change in the information indicating one of:
that the user subscription profile of the user device has changed to currently not be allowed to be modified; and
that the user subscription profile of the user device has changed to currently being allowed to be modified.

12.-15. (canceled)

16. A network node configured to determine whether or not a user subscription profile hosted on an embedded Universal Integrated Circuit Card, eUICC, of a user device is allowed to be modified, the network node comprising a processing unit and a memory, the memory containing instructions executable by the processing unit to configure the network node to:
receive a request to modify the user subscription profile of the user device; and
acquire, from a network node configured to store user subscription information, information indicating if the user device is an autonomous device; and if so
acquire information indicating operational status of the user device; and
allow the user subscription profile to be modified if the information indicating operational status of the user device indicates that the user device currently not is in operation.

17. The network node of claim 16, further configured to:
acquire, from a network node configured to store information related to scheduled user device assignments, information indicating whether or not the user device is scheduled for operation; and
when allowing the user subscription profile to be modified:
allow the user subscription profile to be modified if the acquired scheduling information indicates that the user device is not scheduled for operation within a predetermined time period.

18. The network node method of claim 17, wherein the predetermined time period varies depending on an extent of the user subscription profile modification to be performed.

19. The network node of claim 16, the request being configured to comprise at least one of:
an International Mobile Subscriber Identity, IMSI, associated with the user subscription profile;
an identifier of the eUICC on which the user subscription profile is hosted; and
an identifier of the user device.

20. The network node of claim 16, further configured to:
acquire a current location of the user device and when allowing the user subscription profile to be modified:
allow the user subscription profile to be modified if the acquired location information indicates that the user device is in a location where user subscription profile modification is allowed regardless of user device operational status.

21. The network node of claim 16, further configured to, when acquiring information indicating operational status of the user device:
acquire, from a network node configured to manage mobility of the user device, information indicating operational status of the user device.

22. The network node of claim 16, further configured to, when acquiring information indicating operational status of the user device:
acquire, from the user device, information indicating operational status of the user device.

23. The network node of claim 22, further configured to:
acquire, from a network node configured to manage mobility of the user device, address information of the user device.

24. A subscription manager entity configured to control modification of a user subscription profile hosted on an embedded Universal Integrated Circuit Card, eUICC, of a user device, the subscription manager entity comprising a processing unit and a memory, the memory containing instructions executable by the processing unit to configure the subscription manager entity to:
receive a request to modify the user subscription profile of the user device; and
acquire, from a network node, information configured to indicate whether or not the user subscription profile of the user device is allowed to be modified; and if so
modify the user subscription profile of the user device.

25. The subscription manager entity of claim 24, the request configured to include at least one of:
an International Mobile Subscriber Identity, IMSI, associated with the user subscription profile;
an identifier of the eUICC on which the user subscription profile is hosted; and
an identifier of the user device.

26. The subscription manager entity of claim 24, further configured to, when acquiring the information configured to indicate whether or not the user subscription profile of the user device is allowed to be modified:
subscribe to a change in the information indicating one of:
that the user subscription profile of the user device has changed to currently not be allowed to be modified; and
that the user subscription profile of the user device has changed to currently being allowed to be modified.
